(19) United States
(12) Patent Application Publication
(10) Pub. No.: US 2013/0044317 A1
(43) Pub. Date: Feb. 21, 2013

(54) Active Tracking and Imaging Sensor System Comprising Illuminator Analysis Function

(71) Applicants: James Justice, Newport Beach, CA (US); John Carson, Corona del Mar, CA (US); Medhat Azzazy, Laguna Niguel, CA (US); Ying Hsu, San Clemente, CA (US)

(72) Inventors: James Justice, Newport Beach, CA (US); John Carson, Corona del Mar, CA (US); Medhat Azzazy, Laguna Niguel, CA (US); Ying Hsu, San Clemente, CA (US)

(73) Assignee: ISC8 Inc., Costa Mesa, CA (US)

(21) Appl. No.: 13/563,794

(22) Filed: Aug. 1, 2012

Related U.S. Application Data
(63) Continuation-in-part of application No. 13/397,275, filed on Feb. 15, 2012.
Application No. 13/397,275 is a continuation-in-part of application No. 13/010,745, filed on Jan. 20, 2011.
Application No. 13/010,745 is a continuation-in-part of application No. 13/108,172, filed on May 16, 2011.
(60) Provisional application No. 61/513,910, filed on Aug. 1, 2011.
(60) Provisional application No. 61/336,271, filed on Jan. 22, 2010.
(60) Provisional application No. 61/395,712, filed on May 18, 2010.

(51) Int. Cl. G01J 3/45

(52) U.S. Cl. 356/300; 356/456

(57) ABSTRACT

A sensor suite comprising a LIDAR transmitter and receiver element and a visible imager element. The transmitter operates with a plurality of selectable beam-forming optics or a tilt-tip element. A Risley or counter-rotating prism set element permits beam-steering with lower size, weight and power (SWaP). The optics for the system may be configured in a Cassegrain-type configuration in cooperation with a plurality of beam-splitting elements to permit predetermined spectrums of the received electromagnetic spectrum to be provided respectively to the LIDAR receiver and the visible imager. One or a plurality of laser illuminator analysis spectrometers are provided for the detection of incoming laser illumination from an external source which may be in the form of a micro-lamellar spectrometer element.

### CROSS-REFERENCE TO RELATED APPLICATIONS

This application claims the benefit of U.S. Provisional Patent Application No. 61/513,910, filed on Aug. 1, 2011, entitled “Miniature Active Tracking and Imaging Sensor System” pursuant to 35 USC 119, which application is fully incorporated herein by reference.

This application is a continuation-in-part application of U.S. patent application Ser. No. 13/397,275, filed on Feb. 15, 2012 entitled “Long Range Acquisition and Tracking SWIR Sensor System Comprising Micro-Lamellar Spectrometer”, now pending, pursuant to 35 USC 119, which application is fully incorporated herein by reference.

This application is a continuation-in-part application of U.S. patent application Ser. No. 13/010,745 entitled “Large Displacement Micro-lamellar Grating Interferometer”, now pending, filed on Jan. 20, 2011 which in turn claims priority to U.S. Provisional Patent Application No. 61/336,271, filed on Jan. 22, 2010 entitled “Micro Lamellar Grating Interferometer”, now pending, pursuant to 35 USC 119, which applications are fully incorporated herein by reference.

This application is a continuation-in-part application of U.S. patent application Ser. No. 13/108,172 entitled “Sensor Element and System Comprising Wide Field of View 3-D Imaging LIDAR”, now pending, filed on May 16, 2011, which in turn claims priority to U.S. Provisional Patent Application No. 61/395,712, entitled “Autonomous Landing at Unprepared Sites for a Cargo Unmanned Air System” filed on May 18, 2010, pursuant to 35 USC 119, which applications are fully incorporated herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of LIDAR and electronic imaging systems. More specifically, the invention relates to a multi-imager sensor system comprising a LIDAR system and one or more visible or IR imaging sensor systems using a common received optical input and, in one embodiment, comprising one or more micro-lamellar grating spectrometers for analyzing the frequency and characteristics of an incident illumination laser beam using a portion of the same received optical input.

2. Description of the Related Art

Potentially hostile entities are developing and demonstrating space operations capabilities that threaten the operability and survivability of critical space assets such as communications, navigation, and intelligence satellites. Timely and accurate assessment and warning of potential satellite attacks are key to preserving the operations of U.S. satellite systems and are a national priority. Early detection and accurate assessment are needed for identification and tracking of threatening objects entering the proximity of U.S. satellites.

Space environments are extremely challenging with respect to imaging sensor suites due to the inherent size, weight and power or “SWaP” restrictions inherent in satellite operations coupled with extreme lighting environments which may include very dark environments or full solar exposure, all in the context of the large distances the target may be from the imaging suite.

What is needed is a compact, low-power, lightweight imaging sensor suite that can identify and assess threats to existing space-based assets.

### BRIEF SUMMARY OF THE INVENTION

An imaging sensor system is disclosed that is suitable for use on space-based assets. The sensor system of the invention comprises a LIDAR transmitter and receiver element. One or more selectable holographic beam-forming optical lens elements are provided to shape the LIDAR transmitter laser beam so as to have a predetermined set of optical characteristics, e.g., size and shape. The transmitter preferably is provided to function in cooperation with a plurality of user-selectable beam-forming optics and to cooperate with a tilt-tip or gimbaled element to permit the transmitter to direct electromagnetic laser energy toward a predetermined location within the receiver optics' field of view.

A Risley or counter-rotating prism set element is preferably provided in the objective receiving optics of the system to provide beam-steering capability with a reduction in size, weight and power requirements over that of a gimbaled, optical receiver element.

At least a portion of the optics for the system of the invention may be configured in a Cassegrain-type configuration in cooperation with a plurality of beam-splitting elements which are preferably provided as dichroic beam-splitting elements to permit predetermined spectrums or sub-bands of the received optical input electromagnetic spectrum to be provided separately to the LIDAR receiver FPA and to the visible or other imager FPA.

One or a plurality of laser illuminator spectrometers are provided with suitable support electronics for the detection and analysis of an incoming laser illuminator signal from an external source. Each spectrometer, which may be in the form of a micro-lamellar spectrometer element with suitable support electronics, may be configured and dedicated to the analysis of a predetermined sub-band of the electromagnetic spectrum of the illuminator signal and a plurality of beam-splitter elements provided to direct a predetermined sub-band to each of the spectrometer elements for the analysis of the received sub-band.

The laser illuminator signal analysis outputs from the spectrometer elements of the invention may be configured to cooperate with one or more laser illuminator optical response elements to inject a “glint” or to direct laser energy having a predetermined laser illuminator optical response characteristic toward the source of laser illumination to “blind” or obfuscate the illumination source. In an alternative embodiment, a reflective mirrored tilt-tip element may be provided to direct sunlight toward the laser illumination source to “blind” it.

Dual imagers are provided in the system of the invention such as a visible spectrum FPA and support electronics and a LIDAR imaging FPA and LIDAR read out electronics, which FPA and readout electronics may be in the form of a stacked, multilayer module wherein one or more of the layers in the stack may comprise an application specific integrated circuit in the form of a read out integrated circuit (ROIC) in a stack of ROICs.

The spectrometer/interferometer of the system may comprise a MEMS-fabricated micro-lamellar grating defined by two interleaved reflective mirror sets; a first stationary set of electromagnetically reflective elements and a second moveable set of electromagnetically reflective elements. The first and second set of electromagnetically reflective elements are referred to as first and second sets of mirror elements herein.

The second mirror element set is disposed on a moveable platform supported by flexures and which platform cooperates with and is driven by an actuator element have a predetermined stiffness. Exemplar actuator elements include, without limitation, magnetic, thermal or piezoelectric actuator assemblies designed to provide a predetermined vertical displacement of the second mirror set that is perpendicular to the first mirror set which, in a preferred embodiment is about 500 μm.

While the claimed apparatus and methods herein has been or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts a preferred embodiment of the sensor system of the invention.

FIG. 2 depicts a block diagram of the sensor system of the invention.

FIG. 3 depicts a cross-section of the moveable and stationary mirror elements of a preferred embodiment of the spectrometer of the invention.

FIG. 3A is an interferogram of monochromatic light.

FIG. 4 illustrates a plan view of the spectrometer of the invention comprising magnetic actuator means.

FIG. 4A is a perspective view of the spectrometer of FIG. 4.

FIG. 5 is a sectional view taken along 5-5 of FIG. 4.

FIG. 6 shows a side view of an alternative embodiment of the spectrometer of the invention comprising thermal actuator means.

FIG. 7 is a side view of an alternative embodiment of the spectrometer of the invention comprising piezoelectric stack actuator means.

FIG. 8 illustrates a block diagram of the elements of the spectrometer of the invention.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

Potentially hostile foreign powers are developing and demonstrating space operation capabilities that threaten the operability and survivability of critical space assets, such as communications, navigation, and intelligence satellites critical to defense capabilities. Timely and accurate assessment and warning of potential threats to space-based assets is key to preserving the operations of satellite systems. Early detection and accurate assessment and counter-measures are needed for threatening objects entering the proximity of satellites.

The sensor system of the invention desirably provides an imaging sensor system for assessment, warning and counter-measures with respect to threats to space-based assets such as satellites.

Core electro-optical technologies of the invention are optimized to permit long range threat detection (˜2,000 Km), accurate long range tracking (˜2,000 Km), and accurate assessment (˜1 cm resolution) when threats are in the proximity of a satellite comprising the sensor system of the invention. The size, weight and power (SWaP) of a preferred embodiment of the sensor system is less than about 1.0 ft³, about 10 Kg and about 60 peak watts per unit which permits deployment on many satellite systems.

The invention provides wide field of view for alerting, warning, precision tracking, and target assessment capabilities around key satellite systems upon which it is deployed and has high sensitivity using passive visible sensors to detect possible threats at distant ranges when threats are sun-illuminated. The invention provides enhanced 24/7 observation in its field of view using both passive visible and active LIDAR imaging.

In one mode of operation of the embodiment disclosed in the figures, beam-steering is achieved using a pair of counter-rotating Risley prisms (0-90 degrees) at the objective lens for a received optical input or for a transmitter or for a response signal or any combination thereof. Precision beam steering optical elements such as Risley prism sets desirably provide the ability to rapidly optically direct the laser transmitter, the optical receiver, the response signal or an combination thereof in a predetermined direction.

A yet further embodiment of the invention has the capability of providing laser designator or illuminator analysis and warning (i.e., the ability to sense and analyze an attempt by an adversary to laser scan or image a satellite upon which the sensor system is mounted), by means of a detection spectrometer element or means such as a micro-lamellar interferometer functioning as a spectrometer. The spectrometer element and suitable circuitry are provided on the sensor system of the invention for determining the wavelength or other characteristic of an electromagnetic imaging source such as an unauthorized laser illuminator or designator source.

One such embodiment comprises one or more laser illuminator optical response elements that may be used to counter an adversary's sensor(s) by jamming or obfuscating them by returning laser energy in the same wavelength in the form of “disinformation” as is being used by the adversary to illuminate the sensor system of the invention.

Turning now to the figures wherein like numerals denote like elements among the several views, a dual imager sensor system for use in, for instance, space-based imaging applications is disclosed.

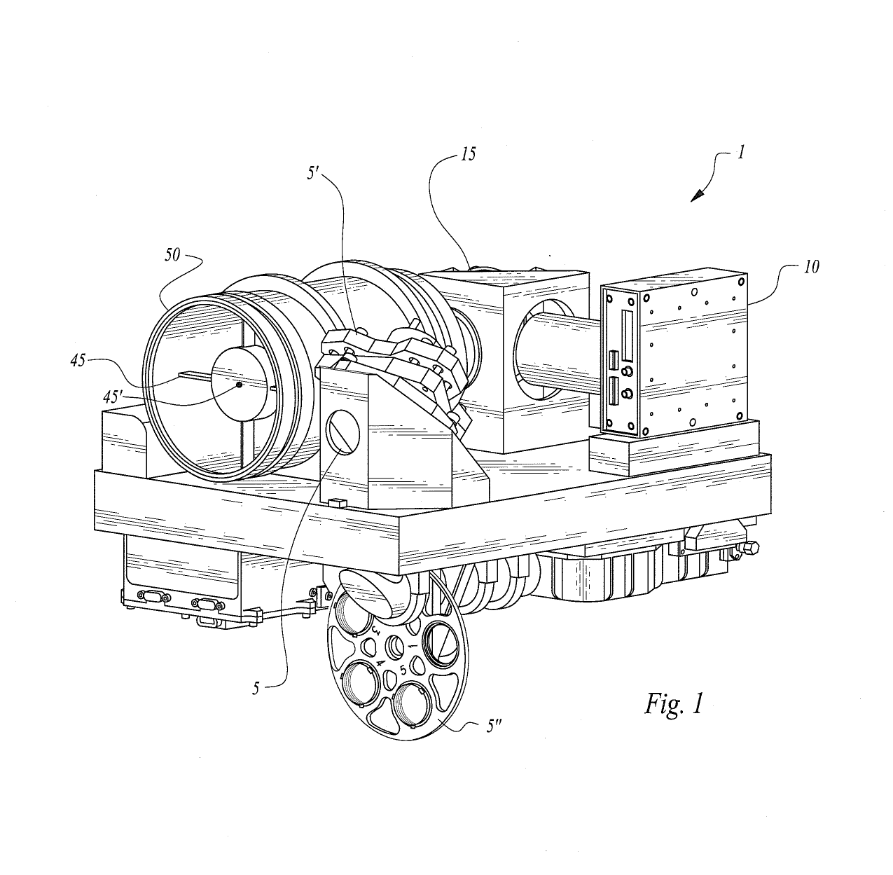

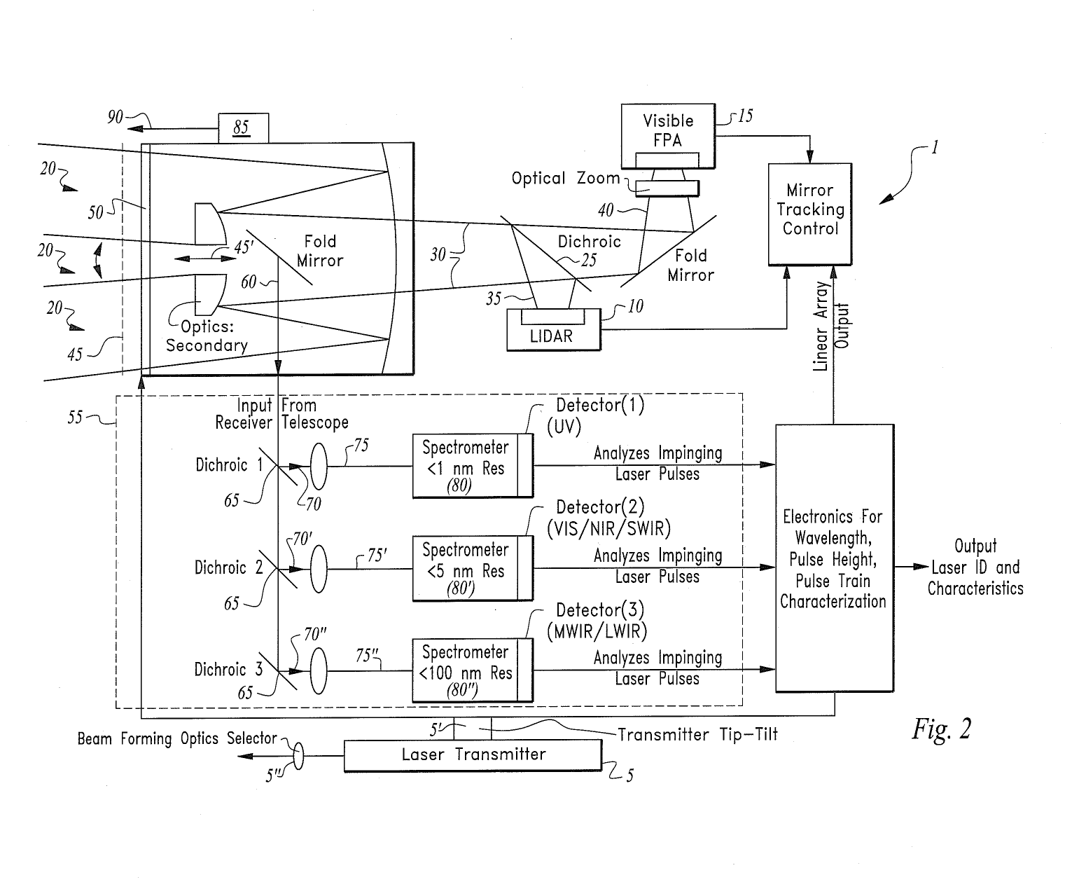

FIGS. 1 and 2 depict a preferred embodiment and block diagram of the sensor system 1 of the invention.

Sensor system 1 comprises a LIDAR imaging element comprising transmitter element 5 and receiver element 10. The LIDAR element is configured for processing and outputting three-dimensional image voxel data from a transmitter laser echo signal as is known to those skilled in the LIDAR imaging arts in a first predetermined portion of a received optical input.

Transmitter element 5 may be provided to be steerable in order to illuminate a target in cooperation with a tip/tilt assembly 5′ and further be provided with one or a user-selectable plurality of beam-forming optics 5″.

Electronic imaging element 15 is configured for processing and outputting electronic image data from a predetermined band of the electromagnetic spectrum in the first portion of the received optical input. Electronic imaging element 15 may comprise a visible, SWIR or LWIR FPA and support circuitry for capturing and outputting image data or any electronic imaging system having suitable responsivity to any user-selected electromagnetic spectrum as is known in the imaging arts.

A received optical input 20 is provided to a first beam-splitting element 25 that is configured to divide the first portion 30 of the received optical input into a first received spectrum 35 and into a second received spectrum 40. The objective lens element 45 through which the received optical input 20 is received may preferably comprise a Risley counter-rotating prism assembly 50 to provide optical beam-steering for the device. In an alternative embodiment, the sensor system 1 may comprise a tip-tilt or gimbaled assembly to replace the need for the use of Risley prism assembly 50 or operate in cooperation therewith to enhance the beam-steering of the device.

First beam-splitting element 25 is configured for inputting the first received spectrum 35 to the receiver element 20 and configured for inputting the second received spectrum 40 to the electronic imaging element 15.

The optics for the system may be configured in a Cassegrain-type configuration in cooperation with a plurality of beam-splitting elements which are preferably dichroic beam-splitting elements to permit predetermined spectrums of the received first portion 30 of the electromagnetic spectrum to be separately provided to the LIDAR receiver FPA and LIDAR support electronics and to the visible FPA and visible FPA support electronics.

In a preferred embodiment, spectrometer element 55 is provided for analyzing an incoming laser illuminator signal characteristic such as frequency, intensity, pulse train length, pulse train height, repetition or other characteristic as from an adversary in a second portion 60 of the received optical input 20 to define one or more characteristics of the illuminator signal. The second portion may be provided to spectrometer 55 through the objective lens 45 by means of aperture 45′.

In view of the fact there are numerous laser wavelengths which may be used to illuminate the sensor system 1 by a third party, spectrometer element 55 preferably comprises a plurality of illuminator signal beam-splitting elements 65 configured to divide the second portion 60 of the received optical input 20 into a plurality of predefined sub-bands, here depicted as 70, 70′ and 70″ of the electromagnetic spectrum and to provide a plurality of individual sub-band illuminator signal outputs 75, 75′ and 75″ from each of the plurality of sub-bands.

A plurality of individual spectrometer elements, here depicted as 80, 80′ and 80″, are each configured to receive one of the plurality of individual sub-band illuminator signals and configured to identify a predetermined characteristic of the individual sub-band illuminator signal such as frequency, intensity, pulse train length, pulse train height, repetition or other characteristic.

Sensor system 1 preferably comprises illuminator optical response element 85, preferably a laser source for outputting an electromagnetic response signal 90 which may be provided to function as a counter-measure to an adversarial illumination attempt and provided to have a predetermined response signal characteristic (e.g., wavelength, intensity, pulse train, etc.) in response to the identification of the predetermined characteristic in the individual sub-band illuminator signal.

In an alternative preferred embodiment, spectrometer element or means 55 is comprised of a micro-lamellar grating interferometer comprising a MEMS fabricated micro-lamellar grating comprising a first stationary set of mirror elements and a second moveable set of mirror elements as is disclosed in U.S. patent application Ser. No. 13/010,745 entitled “Large Displacement Micro-lamellar Grating Interferometer”, now pending, filed on Jan. 20, 2011 and assigned to common assignee, ISC8 Inc.

The first and second set of mirror elements are interleaved whereby the second set of mirror elements may be perpendicularly driven a predetermined distance with respect to the first set of mirror elements. The second set of mirror elements are driven by a flexure element having a predetermined stiffness and actuator means drives the flexure element and second set of mirror elements perpendicularly with respect to the first set of mirror elements.

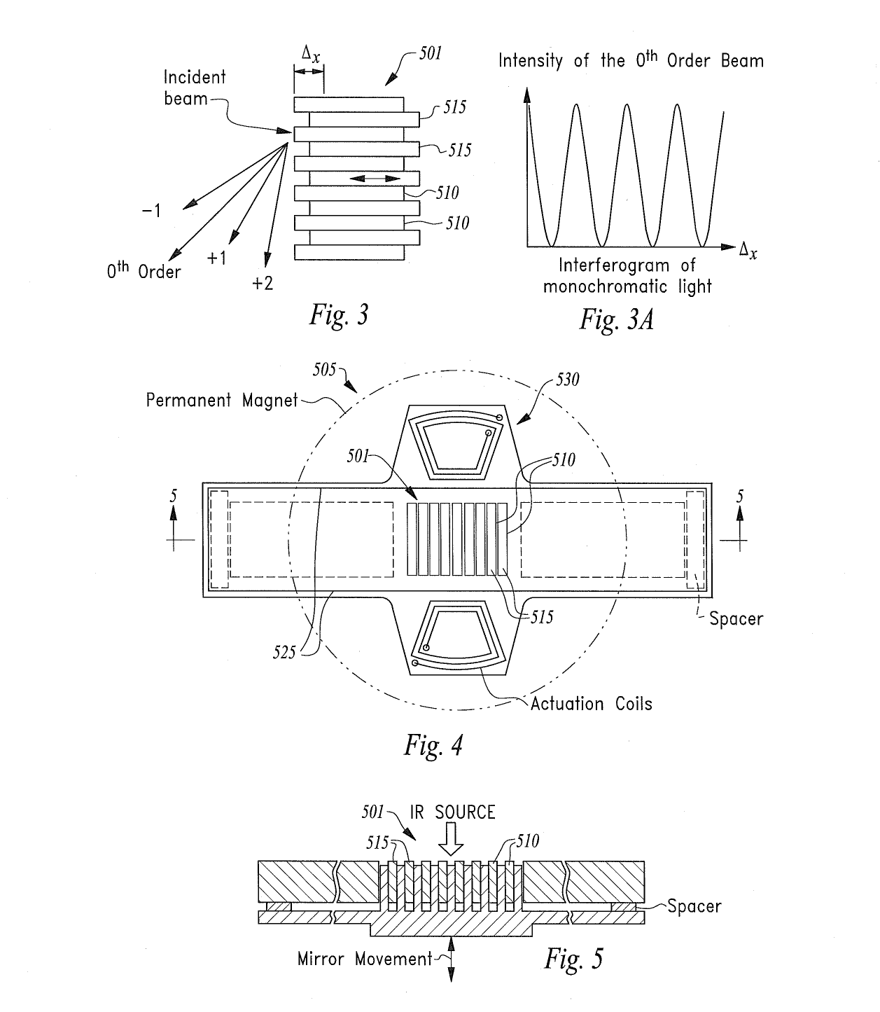

Turning to FIGS. 3-8, wherein like numerals denote like elements among the several views, a micro-lamellar spectrometer grating structure 501 is disclosed that is suitable for use as a laser illuminator or designator spectrometer with the sensor system 1 of the invention.

It is expressly noted that while the disclosed micro-lamellar spectrometer embodiment is well-suited for use with the sensor system 1 of the invention, the invention is not limited to the use of the illustrated micro-lamellar spectrometer in the figures and that any spectrometer means for determining the wavelength of an incoming electromagnetic beam such as a laser designator or illuminator beam may be employed of acceptable SWaP and still fall within the scope of the claims.

The micro-lamellar spectrometer grating structure 501 operates by deriving the spectrum of an incident beam of electromagnetic radiation from, for instance, an adversary's laser imaging or designator source, using a generated interferogram.

The concept of a lamellar grating interferometer was invented by Strong and operates in the 0^{th} order of the grating as generally shown in FIGS. 3 and 3A. A brief explanation of the working principles of a lamellar grating interferometer is set out below.

An electromagnetic beam from a scene of interest is incident on the lamellar grating 501 as shown in FIG. 3. By vertically displacing one set of mirror elements while keeping the other set of mirror elements in a fixed position, two electromagnetic radiation beams are generated and reflected from the grating having an optical path difference between them. The two sets of interleaved mirror elements divide the incident electromagnetic beam into two reflected beams; one by the stationary set of mirror elements and the other by the second set of moveable mirror elements. The optical path difference between the two reflected beams is created by the relative vertical displacement of the first and second sets of mirror elements shown as “depth (Δx)” in FIG. 3, resulting in an interference pattern that is a function of Δx.

The intensity of the 0^{th} order beam is modulated between a minimum and a maximum as Δx decreases and increases. An interferogram is generated by measuring the intensity of the 0^{th} order beam versus Δx. By applying a Fourier Transform to the measured interferogram, the light power spectrum of the incident beam may be then calculated. The resulting power spectrum of the incoming electromagnetic source may be compared against known spectra of laser sources stored in an electronic lookup table for identification.

Prior art MEMS-based lamellar grating interferometers have many deficiencies including the inability to reliably operate outside of the visible and near-IR wavelengths. Further, existing lamellar interferometers are extremely sensitive to shock and vibration such as due to handling or vehicle or aircraft operations.

In contrast with the above deficiencies, the disclosed micro-lamellar grating spectrometer has the ability to operate over the infrared spectrum where certain laser sources are known to have frequency signatures. Additionally, the disclosed spectrometer is ruggedized by having an increased natural resonant frequency; a feature not available in prior art lamellar spectrometers.

The approach of the disclosed invention moves away from the resonant mode of operation used by current MEMS interferometer/spectrometers and instead employs an inherently mechanically stiff actuator system such as a magnetic actuator using an actuation coil and permanent magnet, thermal or piezoelectric actuator means or similar configuration. Desirably, a magnetic actuator can be made small and compact and can achieve resonant frequencies of several KHz (versus a few hundred Hz of the existing MEMS interferometers).

As stated above, other types of stiff actuators are within the scope of the invention, including thermal and piezoelectric actuators as further discussed.

The disclosed spectrometer for use with the sensor system 1 of the invention uses a hybrid MEMS approach to achieve high resolution interferometry while maintaining small size, ruggedness and low power. Compared to the prior art MEMS lamellar spectrometers reported in the literature, the spectrometer invention herein provides at least the following unique technological advantages:

Ultra-large mirror displacement: The spectrometer of the invention may be configured to have a mirror element displacement of greater than 500 μm. Such displacement is considered “ultra-large” for MEMS devices since most MEMS structures are only a few millimeters long and typical relative mirror displacements in prior art devices may be only a few to tens of microns.

Sampling in uniform and discrete increments: One of the difficulties with operating a prior art spectrometer in the resonant mode is the difficulty in sampling the interferogram signal in uniform and discrete intervals. This difficulty is coupled with the non-linearity of the mirror movement and requires that the interferogram data be pre-processed with special algorithms. The additional data processing introduces errors and reduces a system's sensitivity.

On the other hand, the spectrometer of the invention operates in the non-resonant mode and allows the interferogram to be taken in pre-determined discrete increments or, for higher data rates, the spectrometer of the invention can sample in the continuous mode.

High stiffness spectrometer: Another difficulty with operating a spectrometer in the resonant mode is that large mirror element displacement reduces system stiffness and lowers the system's natural frequency. An inverse relationship exists between a system's stiffness and displacement. By using an actuator with high stiffness and operating the spectrometer in the non-resonant mode, the spectrometer of the invention is able to de-couple this fixed relationship and permits both large mirror element displacement and high system stiffness to coexist.

Short response time: The magnetic actuators of the invention can respond quickly (i.e., in milliseconds). The fast response of a magnetic actuator permits the spectrometer of the invention to incorporate closed-loop position feedback circuitry for precise mirror element positioning and for the triggering of detector sampling to produce an interferogram in a very short cycle time.

Miniature size: The small size of the lamellar grating produced using MEMS technology is retained, thus reducing the overall size of the spectrometer. MEMS processing and fabrication is exploited to produce the small and precise grating structures of the device. The same process may be used to produce the supporting structures and actuators. With the spectrometer reduced in size, other components of the spectrometer are reduced to miniaturize the system.

Rugged system: A small and rugged spectrometer is realized. The low mass of the moveable mirror elements is combined with high stiffness actuators and non-resonant operation which means the overall spectrometer system is truly rugged and deployable in the field.

Low power: The instant spectrometer with its low power magnetic actuator ensures low system power consumption and minimizes drain on a power source.

As earlier discussed, lamellar grating interferometry has been used previously for wavelengths in the far infrared (>50 μm) but for shorter wavelengths, the grating structure becomes too fine for conventional machining However, MEMS technology provides an ideal fabrication process for producing the fine structures required for shorter IR wavelengths measured by the spectrometer of the invention.

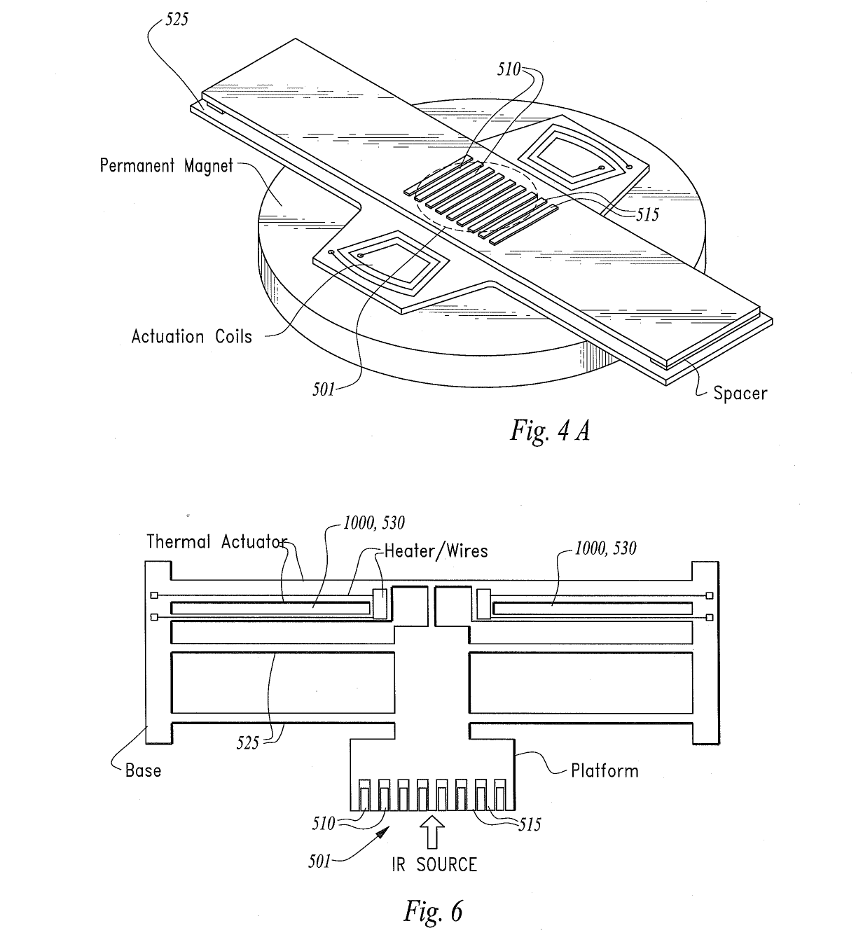

Turning now to FIGS. 4, 4A, and FIG. 5, a preferred embodiment of the micro-lamellar spectrometer 505 of the invention for use with the sensor system of the invention is illustrated. Spectrometer 505 generally comprises a lamellar grating 501 defined by two interleaved reflective mirror sets; a first stationary set of electromagnetically reflective (i.e., mirror) elements and a second moveable set of electromagnetically reflective elements. The first and second set of electromagnetically reflective elements are referred to as first stationary set of mirror elements 510 and second stationary set of mirror elements 515 herein.

The second mirror element set 515 is disposed on a platform that cooperates with and is driven by one or more flexures 525, which platform and flexures are driven in a vertical direction by actuator means 530. A preferred actuator means comprises a high stiffness magnetic actuator means for driving second mirror element 515 set vertically relative to first mirror set 510.

Flexures 525 may be configured as a plurality of cantilevered beams or, as seen in the figures, flexures 525 are a flexure or flexure system with a surface that is substantially coplanar or substantially parallel to the support assembly upon which the first mirror elements are disposed. In a preferred embodiment, flexures 525 are fabricated from a silicon material in a MEMS fabrication process and provide a flexure structure with desirable low hysteresis and yield.

Magnetic, thermal or piezoelectric actuator means or other high vertical displacement means are suitable actuator means 530 and are configured to provide a predetermined vertical displacement, i.e., a second mirror set 515 displacement that is substantially perpendicular to first mirror set 510. A preferred embodiment of actuator means 530 provides a relative vertical displacement of about 500 μm.

Alternatively, the instant device can be designed to cover a broader range of wavelengths such as from visible to LWIR or other predetermined range of the electromagnetic spectrum as is known in the field of spectrometry. In selecting the wavelengths, consideration should be given to the atmospheric transmission (for remote detection), optical component interconnections (optical fiber) and the availability and cost of broadband electromagnetic detectors with high sensitivity.

As discussed earlier, prior art resonant-based spectrometers generally have a fixed relationship between the mirror element displacement and system stiffness. The instant spectrometer avoids this deficiency and uses a non-resonant system that decouples the system stiffness and displacement. By having a non-resonant system, the actuator of the invention has the benefit of high inherent stiffness, high resonant frequency, and can be used with any actuator means 530 that offers ultra-large displacement and high inherent stiffness.

The high inherent predetermined stiffness of the flexure 525 of the invention permits mirror displacement or stroke travel distances unachievable in prior art MEMS-based interferometers that use, for instance, electrostatic comb drive mechanisms. Prior art electrostatic comb drive mechanisms are typically designed for travel of less than ten microns and travel distances of tens of microns are considered large in comb drive applications. One hundred microns of stroke travel is considered very large travel in a prior art comb drive application.

The disclosed flexure arrangement using magnetic, piezoelectric or thermal actuator means permits a mirror travel distance of about 500 microns which is difficult, if not impossible, to achieve with state-of-the-art comb drive actuators due at least in part to the electrostatic comb drive structure's instability resulting from lateral forces.

Magnetic actuator means for displacement of the second set of moveable minor elements 515 is well-suited for use in the instant lamellar grating spectrometer. Magnetic actuators can be driven to very large displacements and when operating in the closed-loop control, the actuator achieves high stiffness.

Advantages of the magnetic actuator include high stiffness, ultra-large displacement, short response time, fine displacement resolution and high actuation force.

As illustrated in FIGS. 4, 4A and the sectional view of FIG. 5, the grating 501 of first and second sets of mirror elements is located in about the center of the device. The two sets of mirror elements are interleaved to form the grating 501. In the illustrated embodiment, the mirror set on the “top” is a stationary mirror set 510 that is supported on a platform. Openings in the first stationary set of mirror elements 510 permits a second moveable set of mirror elements 515 to be slideably interleaved there between to define a lamellar grating 501.

In the illustrated embodiment, the second moveable set of mirror elements 515 is disposed on a platform that is supported by flexures 525 on each side of grating 501. These flexures 525 are precisely etched in a MEMS process and are formed as an integral part of the platform. The flexures 525 ensure precise movement of the second set of moveable mirror elements 515 and can be configured to prevent them from coming in contact with lower surface the first stationary set of mirror elements 510.

In the magnetic actuator embodiment of FIGS. 4 and 4A, the magnetic actuator 530 may be defined by a set of actuation coils mounted on the lower surface of the second set of moveable mirror elements 515. The actuation coils are designed to cooperate with a permanent magnet that is positioned at a predetermined distance from the second set of moveable mirror elements 515. When electric current is passed through the actuation coils, the interaction between the current and the magnetic flux produces an electromotive force. The conventional expression for the magnetic force is expressed as:

Fm=IxB

Where Fm is the magnetic force; I is the current and B is the magnetic flux. All three parameters are vectors and the “x” is the cross-product operator. By suitably designing the actuation coil geometry and aligning the permanent magnet, a net force is generated. The magnitude of the force and hence displacement, is controlled by modulating the current flow.

An accurate determination of the second mirror set position over the full length of travel is a consideration for the spectrometer in achieving high accuracy. Position feedback may be obtained in several ways including capacitive sensing, inductive sensing from the actuation coils (a stationary coil transmits AC magnetic field is needed) or the use of a laser reference system.

Very high forces are achievable using the magnetic actuator (sub-Newtons) embodiment. When combined with a high-bandwidth closed-loop control system, the system's natural frequency can reach several KHz.

In another embodiment, the use of thermal actuator means 530 provides an alternative moveable mirror set displacement means with high force and high displacement actuation. The thermal actuator embodiment takes advantage of the dissimilar expansion of two parallel beams 1000 to produce a “bi-morph” element bending.

In the thermal actuator embodiment of FIG. 6, the tip of the bending beams in the thermal actuator achieves large vertical displacements. The two beams 1000 are designed with different widths, producing different rates of thermal conduction. The resulting difference in the thermal gradients produces the bending of beams 1000. An integral heater is provided on the thermal actuators to provide a means for introduction and control of the heat source. To actuate the second set of moveable mirror elements 515, an electrical current is passed through the heaters located on the thermal actuators.

As before, the lamellar grating 501 of the thermally-actuated embodiment is formed by two interleaved first stationary and second moveable sets of minor elements. The second set of moveable mirror elements 515 is connected to a structure such as a platform supported by and driven by a pair of parallel flexures. The structure cooperates with and is driven by the thermal actuators. The first stationary set of mirror elements 510 is fixed to the substrate and is interleaved with the second set of moveable mirror elements 515.

Thermal actuators provide high displacement and high stiffness but unlike magnetic actuators, these two design parameters are not decoupled. In practice, the design of the actuator geometry is driven by actuation force and displacement and once these requirements are met, the stiffness of the actuators is fixed. Although optimization of the design can provide some compromise between displacement and stiffness, the de-coupling of these parameters is limited in this embodiment.

A concern with the use of thermal actuators is that the performance is sensitive to the thermal environment. Depending on the method of mounting and packaging chosen for device, the actuator displacement can vary as the temperature of the substrate changes. Careful design of the actuator and device packaging ensures consistent performance.

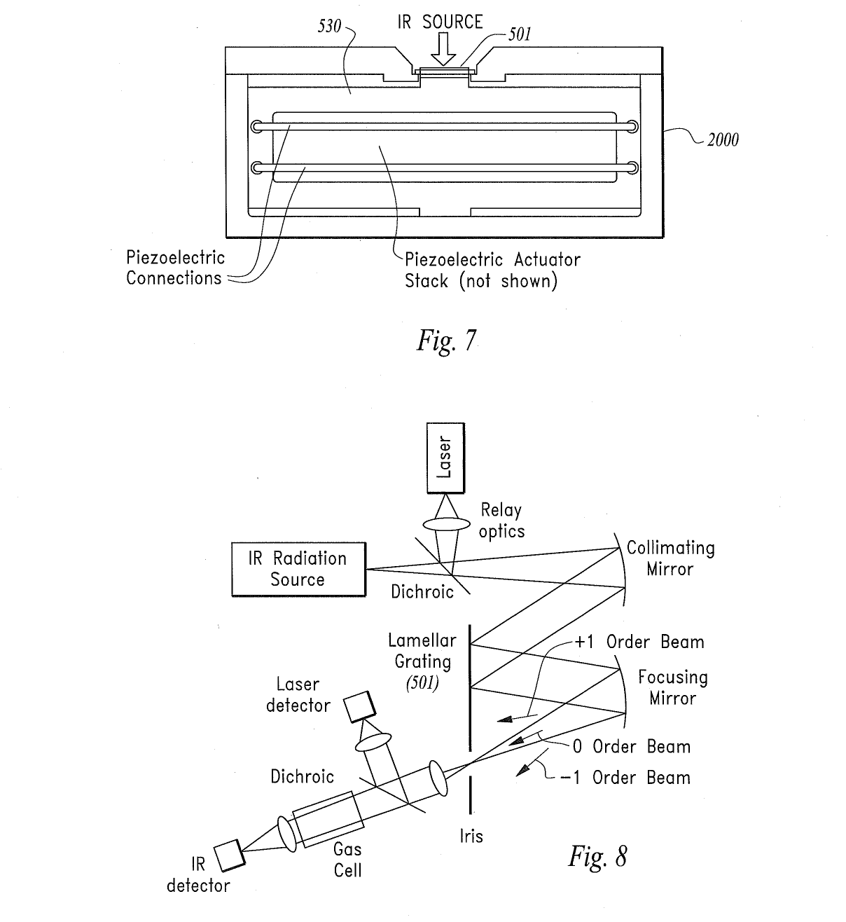

Yet a third preferred embodiment for producing an ultra-large displacement and high stiffness system is by using piezoelectric actuators as depicted in FIG. 7.

Chip scale integration of MEMS and piezoelectric actuators have been demonstrated at low displacements but displacements in the range of 500 μm require a large number of piezoelectric disks making this embodiment difficult to achieve using chip scale. The alternative to chip scale integration is the use of commercially available, separately fabricated miniature piezoelectric actuators.

Commercially available piezoelectric actuators are designed and are commercially available in the form of a stack of piezoelectric disks integrated in a flexure frame for precise movement. An example of a suitable piezoelectric actuator means 530 is the FlexFrame PiezoActuator™ family of actuators produced by Dynamics Structures & Materials, LLC (Franklin, Tenn.). Depending on the size, these miniature actuators produce a displacement in excess of 500 μm. These piezoelectric actuators are relatively large compared to magnetic and thermal actuators, with the largest dimensions of a 500 μm actuator currently measuring about 46 mm×16 mm.

In addition to the ultra-large displacement, the piezoelectric actuators have very high stiffness. For actuators with a 500 μm movement, the stiffness is on the order of sub- to several Newtons per μm.

In the piezoelectric embodiment of FIG. 7, an external support frame 2000 may be used to support the stationary element of the grating 501, with the piezoelectric actuator attached to the second set of moveable mirror elements 515. The overall size of the device in this exemplar embodiment measures approximately 51 mm×22 mm (2.0 in×0.9 in).

A related issue with the piezoelectric embodiment shown in FIG. 7 is the sensitivity of the system to temperature changes. With the external frame and the piezoelectric actuator supporting different parts of the mirrors, any mismatch in the thermal expansion or contraction may cause a misalignment of the mirror sets, thus reducing accuracy. The effect of the mismatch can potentially be reduced by careful design and software compensation.

One or more spectrometers 505 may be provided at any predetermined location or locations on the sensor system of the invention, the output or outputs of which can be used to determine the wavelength or wavelengths of an electromagnetic spectrometer input signal such as a laser designator illuminator source for analysis and appropriate response.

In one embodiment of the sensor system of the invention, the input to the spectrometer 505 may be an electromagnetic laser beam received from a dichroic filter element provided as part of the optical path of the sensor system as depicted in FIG. 8.

The spectrometer element may comprise a second mirror set position feedback means. The thermal actuator means may comprise a bi-morph element. The piezoelectric actuator means may comprise a plurality of stacked piezoelectric disk elements. The position feedback means may comprise capacitive sensing means. The position feedback means may comprise inductive sensing means. The position feedback means comprises laser reference means. The sensor may comprise circuitry for performing a Fast Fourier Transform.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A sensor system comprising:
A LIDAR element comprising a transmitter element and a receiver element, the LIDAR element configured for processing and outputting three-dimensional image voxel data from a transmitter echo signal in a first predetermined portion of a received optical input,
an electronic imaging element configured for processing and outputting electronic image data from a predetermined band of the electromagnetic spectrum in the first portion of the received optical input,
a first beam-splitting element configured to divide the first portion of the received optical input into a first received spectrum and into a second received spectrum, the first beam-splitting element configured for inputting the first received spectrum to the receiver element and configured for inputting the second received spectrum to the electronic imaging element, and,
a spectrometer element configured for analyzing a laser illuminator signal in a second portion of the received optical input to define one or more characteristics of the illuminator signal.

2. The sensor system of claim 1 wherein the spectrometer element comprises a plurality of illuminator signal beam-splitting elements configured to divide the second portion of the received optical input into a plurality of predefined sub-bands of the electromagnetic spectrum and to provide a plurality of individual sub-band illuminator signal outputs from each of the plurality of sub-bands, and,
a plurality of individual spectrometer elements, each configured to receive one of the plurality of individual sub-band illuminator signals and configured to identify a characteristic of the individual sub-band illuminator signal.

3. The sensor system of claim 2 further comprising an illuminator optical response element for outputting an electromagnetic response signal having a predetermined response signal characteristic in response to the identification of the characteristic in the individual sub-band illuminator signal.

4. The sensor system of claim 3 wherein the transmitter element is steerable in cooperation with a tip/tilt element.

5. The sensor system of claim 3 where the received optical input is received through a Risley prism beam-steering element.

6. The sensor system of claim 3 wherein the spectrometer element is comprised of a micro-lamellar grating interferometer comprising a lamellar grating comprising a first stationary set of mirror elements and a second moveable set of mirror elements,
the first and second set of mirror elements interleaved whereby the second set of mirror elements may be perpendicularly driven a predetermined distance with respect to the first set of mirror elements,
the second set of mirror elements driven by a flexure element having a predetermined stiffness, and,
actuator means for driving the flexure element and second set of mirror elements perpendicularly with respect to the first set of mirror elements.

7. The sensor system of claim 6 where the actuator means comprises magnetic actuator means.

8. The sensor system of claim 6 wherein the actuator means comprises thermal actuator means.

9. The sensor system of claim 6 wherein the actuator means comprises piezoelectric actuator means.

10. The sensor system of claim 6 further comprising second mirror set position feedback means.

11. The sensor system of claim 6 wherein the thermal actuator means comprises a bi-morph element.

12. The sensor system of claim 6 wherein the piezoelectric actuator means comprises a plurality of stacked piezoelectric disk elements.

13. The sensor system of claim 6 wherein the position feedback means comprises capacitive sensing means.

14. The sensor system of claim 6 wherein the position feedback means comprises inductive sensing means.

15. The sensor system of claim 6 wherein the position feedback means comprises laser reference means.

16. The sensor system of claim 6 further comprises circuitry for performing a Fast Fourier Transform.
